(19) United States
(12) Patent Application Publication
(10) Pub. No.: US 2025/0370553 A1
(43) Pub. Date: Dec. 4, 2025

(54) INTERACTION CONTROL METHOD, ELECTRONIC DEVICE, AND STORAGE MEDIUM

(71) Applicant: Beijing Zitiao Network Technology Co., Ltd., Beijing (CN)

(72) Inventors: Mengqian LIU, Beijing (CN); Shuo LIU, Beijing (CN); Rongxuan MU, Beijing (CN); Xujie TAO, Beijing (CN); Jia GUO, Beijing (CN); Chin-Wei LIU, Beijing (CN)

(21) Appl. No.: 19/223,717

(22) Filed: May 30, 2025

(30) Foreign Application Priority Data
May 30, 2024 (CN) 202410693010.1

(51) Int. Cl. G06F 3/03; G06F 3/01

(52) U.S. Cl. CPC G06F 3/03; G06F 3/011

(57) ABSTRACT

The present disclosure provides an interaction control method and apparatus, an electronic device, and a storage medium. The interaction control method includes: determining a first displacement vector of a first object in response to a moving event of the first object; determining a first projection vector of the first displacement vector in a user local coordinate system and a second projection vector of the first displacement vector in a target coordinate system; obtaining a second displacement vector according to a harmonic calculation result of the first projection vector and the second projection vector; and controlling a state of a second object in a target region according to the second displacement vector, the target coordinate system is a coordinate system used for the target region, and the second object is limited in the target region.

### CROSS-REFERENCE TO RELATED APPLICATION

This application claims the priority to and benefits of the Chinese Patent Application, No. 202410693010.1, which was filed on May 30, 2024. The aforementioned patent application is hereby incorporated by reference in its entirety.

### TECHNICAL FIELD

The present disclosure relates to an interaction control method and apparatus, an electronic device, and a storage medium.

### BACKGROUND

In an interactive interface, an object in a display region is often controlled according to a controller held by a user or according to a hand of the user. Usually, a moving distance of the object in the display region is controlled according to a displacement distance of the controller or the hand of the user.

### SUMMARY

The present disclosure provides an interaction control method and apparatus, an electronic device, and a storage medium.

The present disclosure adopts the following technical solutions.

In some embodiments, the present disclosure provides an interaction control method, including:
determining a first displacement vector of a first object in response to a moving event of the first object;
determining a first projection vector of the first displacement vector in a user local coordinate system and a second projection vector of the first displacement vector in a target coordinate system;
obtaining a second displacement vector according to a harmonic calculation result of the first projection vector and the second projection vector; and
controlling a state of a second object in a target region according to the second displacement vector;
the target coordinate system is a coordinate system used by the target region, and the second object is limited in the target region.

In some embodiments, the present disclosure provides an interaction control apparatus, including:
a processing unit, configured to determine a first displacement vector of a first object in response to a moving event of the first object;
the processing unit is further configured to: determine a first projection vector of the first displacement vector in a user local coordinate system and a second projection vector of the first displacement vector in a target coordinate system;
the processing unit is further configured to: obtain a second displacement vector according to a harmonic calculation result of the first projection vector and the second projection vector;
a control unit, configured to control a state of a second object in a target region according to the second displacement vector;
the target coordinate system is a coordinate system used for the target region, and the second object is limited in the target region.

In some embodiments, the present disclosure provides an electronic device, including: at least one memory and at least one processor;

the memory is configured to store program codes, and the processor is configured to invoke the program codes stored in the memory to perform the above method.

In some embodiments, the present disclosure provides a computer-readable storage medium, the computer-readable storage medium is configured to store program codes, the program codes, when run by a processor, cause the processor to perform the above method.

### BRIEF DESCRIPTION OF DRAWINGS

The above and other features, advantages, and aspects of the embodiments of the present disclosure will become more apparent when taken in conjunction with the drawings and with reference to the following specific implementations. Throughout the drawings, the same or similar reference numerals represent the same or similar elements. It should be understood that the drawings are schematic and that elements and components are not necessarily drawn to scale.

FIG. 1 is a flowchart of an interaction control method according to an embodiment of the present disclosure.

FIG. 2 is a schematic diagram of a user local coordinate system according to an embodiment of the present disclosure.

FIG. 3 is a schematic diagram of a user local coordinate system and a target coordinate system according to an embodiment of the present disclosure.

FIG. 4 is a schematic diagram of a user controlling a second object according to an embodiment of the present disclosure.

FIG. 5 is a schematic diagram of a user controlling a second object according to an embodiment of the present disclosure.

FIG. 6 is a schematic diagram of a user controlling a second object according to an embodiment of the present disclosure.

FIG. 7 is a schematic diagram of a first displacement vector according to an embodiment of the present disclosure.

FIG. 8 is a schematic diagram of determining a second displacement vector according to an embodiment of the present disclosure.

FIG. 9 is a schematic diagram of a usage effect according to an embodiment of the present disclosure.

FIG. 10 is a schematic structural diagram of an electronic device according to an embodiment of the present disclosure.

### DETAILED DESCRIPTION

It should be understood that before using the technical solutions disclosed in the embodiments of the present disclosure, the user should be informed of the type, use scope, use scene, etc. of the personal information involved in the present disclosure in an appropriate manner according to relevant laws and regulations, and the authorization of the user should be obtained.

For example, when receiving an active request from the user, prompt information is sent to the user, to explicitly prompt the user that the operation requested to be performed will require the acquisition and use of the personal information of the user. Thus, the user can independently choose whether to provide the personal information to software or hardware such as an electronic device, an application, a server, or a storage medium that performs the operation of the technical solution of the present disclosure according to the prompt information.

As an optional but non-limiting implementation, the manner of sending the prompt information to the user in response to receiving the active request from the user may be, for example, a pop-up window, and the prompt information may be presented in the pop-up window in the form of text. In addition, the pop-up window may also carry a selection control for the user to select “agree” or “disagree” to provide the personal information to the electronic device.

It should be understood that the above process of notifying and obtaining the user authorization is only schematic, and does not constitute a limitation on the implementations of the present disclosure. Other manners that meet relevant laws and regulations may also be applied to the implementations of the present disclosure.

It should be understood that the data involved in the technical solution (including but not limited to the data itself, the acquisition or use of the data) should comply with the requirements of corresponding laws, regulations, and related provisions.

The embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for illustrative purposes, and are not intended to limit the protection scope of the present disclosure.

It should be understood that the various steps recited in the method implementations of the present disclosure may be performed sequentially and/or in parallel. Additionally, the method implementations may include additional steps and/or omit to perform illustrated steps. The scope of the present disclosure is not limited in this respect.

As used herein, the term “include/comprise” and its variants are open-ended inclusions, that is, “include/comprise but not limited to”. The term “based on” is “based, at least in part, on”. The term “an embodiment” means “at least one embodiment”. The term “another embodiment” means “at least one additional embodiment”. The term “some embodiments” means “at least some embodiments”. Related definitions of other terms will be given in the following description.

It should be noted that concepts such as “first” and “second” mentioned in the present disclosure are only used to distinguish between different apparatuses, modules, or units, and are not used to limit the order or interdependence of functions performed by these apparatuses, modules, or units.

It should be noted that the modification of “one” mentioned in the present disclosure is illustrative and not restrictive, and those skilled in the art should understand that it should be understood as “one or more” unless the context clearly indicates otherwise.

The names of messages or information exchanged between multiple apparatuses in the implementations of the present disclosure are only for illustrative purposes, and are not intended to limit the scope of these messages or information.

The solutions provided by the embodiments of the present disclosure will be described in detail below with reference to the drawings.

In an interactive interface, for example, in a virtual display world, an object on a display region (for example, a display screen in a certain display panel in the virtual reality world) is often controlled according to a controller (such as a handle) held by a user. There are multiple ways to convert a moving vector of the controller to a moving vector of the object. Due to different perceptions, any conversion method will lead to a drop in the expectations of some users, resulting in poor user experience.

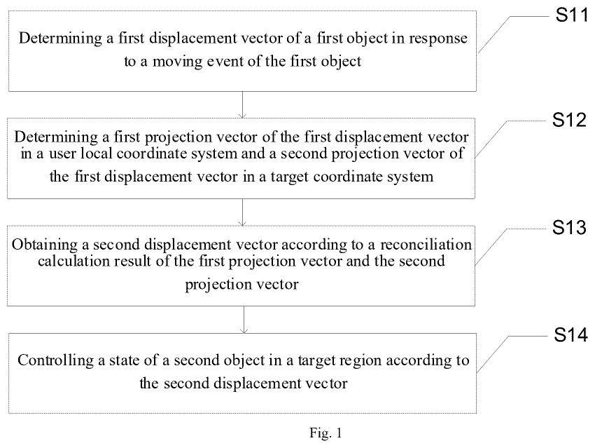

As shown in FIG. 1, FIG. 1 is a flowchart of an interaction control method according to an embodiment of the present disclosure, including the following steps.

S11, determining a first displacement vector of a first object in response to a moving event of the first object.

In some embodiments, the method proposed in the present disclosure may be used for an extended reality device such as a virtual reality device, an augmented reality device, or a mixed reality device, and may also be used for a terminal device such as a mobile phone, a tablet, or a computer. The first object may be a controller (such as a handle) capable of controlling the second object, and the first object may also be a hand of the user. The user may move the first object, and then determine the first displacement vector of the first object through a sensor (for example, the sensor may be built in the controller) or a photographing manner. The first displacement vector describes a moving direction and a moving distance (modulus) of the first object.

S12, determining a first projection vector of the first displacement vector in a user local coordinate system and a second projection vector of the first displacement vector in a target coordinate system.

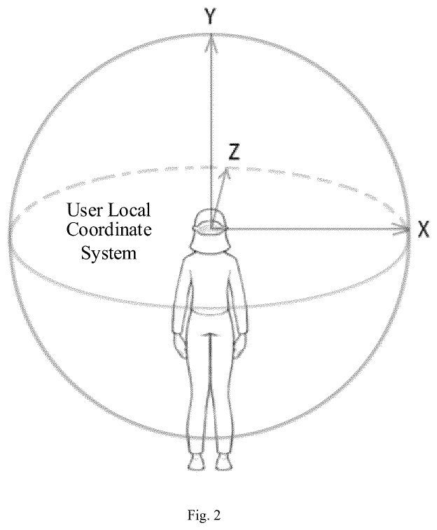

In some embodiments, FIG. 2 schematically shows a user local coordinate system. A pose of the user local coordinate system changes with a change of a pose of the user. Usually, a face orientation of the user, a left-right direction of the user, and a head-top direction of the user are used as three coordinate axes of the user local coordinate system. Therefore, a direction of the user local coordinate system changes with different orientations of the user, but a relative position of the user local coordinate system and the user remains unchanged. The first projection vector may be calculated by projecting the first displacement vector. In some cases, if the user local coordinate system adopts a plane coordinate system (for example, only the plane coordinate system composed of the x-axis and the y-axis as shown in FIG. 2 may be adopted), the first displacement vector is projected into the plane coordinate system. In some embodiments, the target coordinate system is a coordinate system used for the target region. The user local coordinate system may have an offset angle relative to the target coordinate system, and the offset angle is greater than zero. Specifically, one plane in the user local coordinate system (for example, a plane defined by the x-axis and the y-axis) and the same plane in the target coordinate system (for example, a plane defined by the x-axis and the y-axis) may be non-parallel. The target region may be a display region displayed in a display panel, and the display panel may be a virtual display panel or a physical display panel. The target coordinate system may be a three-dimensional coordinate system, a two-dimensional coordinate system, or even a one-dimensional coordinate system. For example, a coordinate system with a horizontal direction and a vertical direction of the display region of the display panel as coordinate axes. The second object is limited in the target region. The second object may be physical or virtual. When the target region is the display region in the display panel, the second object may be a virtual object displayed in the display region. The state of the second object may be controlled by moving the first object, for example, a position of the second object in the target region may be controlled, or a posture of the second object in the target region may be controlled.

In S13, a second displacement vector is obtained according to a harmonic calculation result of the first projection vector and the second projection vector.

In some embodiments, after the first projection vector and the second projection vector, a harmonic calculation will be performed. The harmonic calculation result may be directly used as the second displacement vector, or the second displacement vector may be obtained through further adjustment based on the harmonic calculation result. In some embodiments of the present disclosure, an offset angle of the user local coordinate system relative to the target coordinate system is greater than zero.

In S14, controlling a state of the second object in the target region according to the second displacement vector.

In some embodiments, after the second displacement vector is obtained, the state of the second object in the target region will be controlled, for example, a position or a posture of the second object in the target region may be controlled.

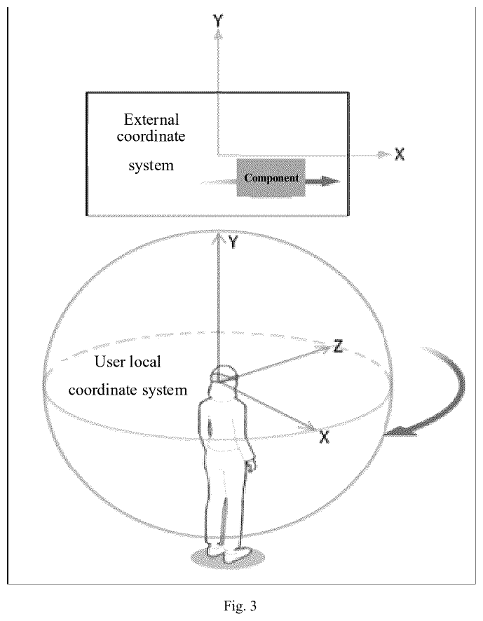

To better illustrate the method proposed in the embodiments of the present disclosure, a specific embodiment is listed below. The method proposed in the present disclosure may be used for a virtual reality device. There may be a virtual display panel in a virtual reality space, and a display region of the virtual display panel is used as a target region. As shown in FIG. 3, FIG. 3 shows a user and a display region of a display panel in a virtual reality space. An external coordinate system in FIG. 3 is a target coordinate system, a rectangular frame where the external coordinate system is located is a display region of the virtual display panel, and a component displayed in the display region of the display panel is used as a second object. A plane where the target region is located is parallel to the x-axis and the y-axis in the target coordinate system, and a plane where the x-axis and the y-axis of the target coordinate system are located corresponds to a plane composed of the x-axis and the y-axis of the user local coordinate system. Because the second object is displayed in the target region, its degree of freedom of movement is limited by the target region. The second object may move with the movement of the first object. In this embodiment, the external coordinate system may be a two-dimensional plane coordinate system, and the user local coordinate system is a three-dimensional coordinate system. The plane where the external coordinate system is located corresponds to the plane where the x-axis and the y-axis in the user local coordinate system are located.

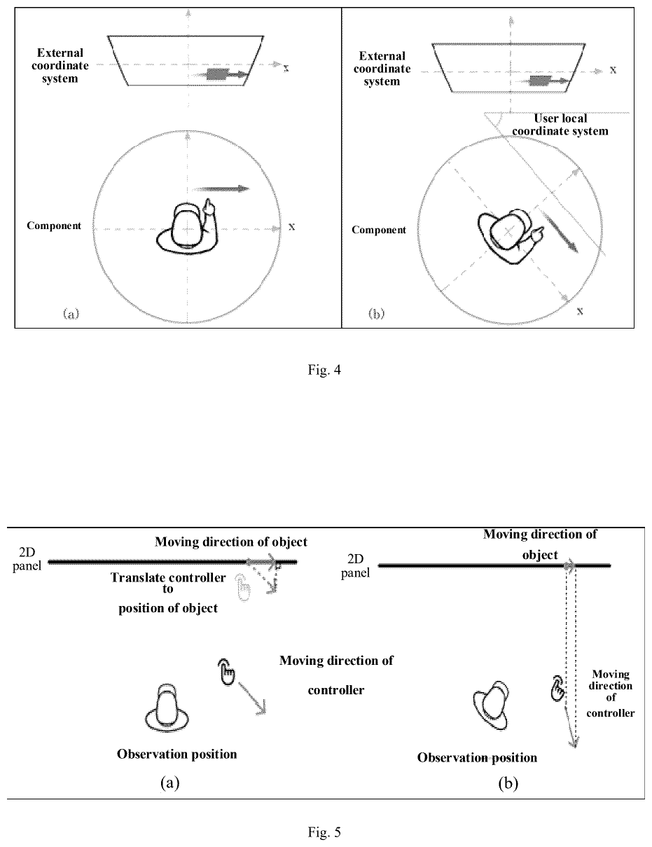

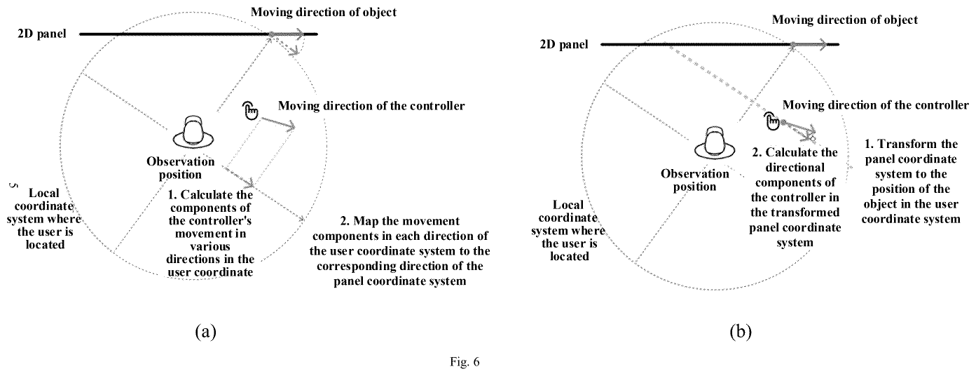

As shown in FIG. 4(a), when the plane corresponding to the external coordinate system and the user local coordinate system are parallel to each other, there is no difference in perception, that is, the perception of the up-down, left-right, and front-back movement of the first object (the hand of the user in FIG. 4(a)) is the same as the perception of the up-down, left-right, and front-back movement of the second object. At this time, the results of controlling the second object with reference to the position change of the first object in the user local coordinate system or the external coordinate system are the same. However, when the plane corresponding to the user local coordinate system and the external coordinate system are non-parallel and have an offset angle with each other, as shown in FIG. 4(b), there is an offset angle between the x-axis of the user local coordinate system and the x-axis of the external coordinate system, and at this time, a perception difference will occur. At this time, the perception of the up-down, left-right, and front-back movement of the first object in the user local coordinate system is inconsistent with the perception of the up-down, left-right, and front-back movement of the second object. For example, the user moves the first object in the direction of the x-axis in the user local coordinate system, while from the perspective of the external coordinate system, this moving operation has a component along the direction perpendicular to the x-axis of the external coordinate system, which may cause the second object to move in the direction perpendicular to the x-axis. That is, when the user local coordinate system has an offset angle relative to the external coordinate system, the movement of the first object by the user is inconsistent with the movement of the second object, resulting in ambiguity. As shown in FIG. 4, taking the target region as the display region of the display panel as an example, when the user is facing the display panel and the operating object on the display panel, the “left and right” in the user local coordinate system is consistent with the “left and right” in the 2D panel, and there is no ambiguity at this time. However, when the user local coordinate system rotates an angle, the direction of the user local coordinate system is inconsistent with the direction of the external coordinate system of the display panel. At this time, there is an angle between the “left and right” in the external coordinate system and the “left and right” in the user local coordinate system. In this case, there are two possible calculation modes. The first calculation mode is based on the external coordinate system. As shown in FIG. 5(a), after the first object (the controller in FIG. 5) moves, the second object is controlled according to the projection component of the first moving vector of the first object on the display panel (the 2D panel in FIG. 5), that is, it is equivalent to translating the controller to the position of the second object in the display panel for control. The moving direction of the second object (the moving return of the object) is the projection direction of the moving vector determined by the axis decomposition method in the external coordinate system, and the moving distance is the length of the projection component of the first moving vector of the first object on the display panel. As shown in FIG. 5(b), the problem with this calculation mode is that as the offset angle between the user local coordinate system and the external coordinate system increases, the projection component of the first moving vector in the external coordinate system will continue to decrease, resulting in a continuous decrease in the moving distance of the second object on the display panel, resulting in a situation where it cannot be dragged. The second calculation mode is to map the user local coordinate system to the external coordinate system. As shown in FIG. 6(a), first, the projection components of the first moving vector of the first object (the controller in FIG. 6) on each axis of the user local coordinate system are calculated, and then the projection components are directly mapped to the corresponding axes of the external coordinate system (the panel coordinate system in FIG. 6) instead of projecting. As shown in FIG. 6(b), this calculation mode is equivalent to moving the plane where the display panel is located to the position of the first object (the controller), and rotating the plane where the display panel is located to be perpendicular to the line connecting the user and the second object. The projection components of the first moving vector on each axis of the user local coordinate system are used as the moving vectors of the second object on each axis. In the display panel after the movement, the movement of the first object will be mapped to the display panel at an equal distance. For example, assuming that the projection components of the first moving vector in the user local coordinate system in FIG. 6(a) are 5-unit lengths along the positive direction of the x-axis and 3-unit lengths along the positive direction of the y-axis, the second object will move 5-unit lengths along the positive direction of the x-axis in the external coordinate system, and 3-unit lengths along the positive direction of the y-axis in the external coordinate system. Different people have different preferences for these two calculation modes, and even the preferences of the same person may change in different situations. For example, in an extreme case where the user's line of sight is almost parallel to the right side of the display panel, under the first calculation mode, the user hopes to control the second object to move to the right side of the panel by pushing the first object forward, while under the second perception mode, the user hopes to control the second object to move to the right side of the panel by pulling the first object to the right. No matter which calculation mode is selected, the expectation of some users will be reduced.

In the embodiments of the present disclosure, the second displacement vector is determined according to the harmonic calculation result of the first projection vector and the second projection vector, and the state of the second object in the target region is controlled through the second displacement vector. In this embodiment, the first projection vector and the second projection vector are synthesized, so as to reconcile the two calculation modes, thereby avoiding an excessive deviation between the state of the second object and an expectation of the user.

In some embodiments, the first displacement vector may be determined by shooting the first object with a camera, the first projection vector and the second projection vector may be determined by using the above interaction control method for the first displacement vector of each frame position of the first object, and then the second displacement vector is determined. The second displacement vector may be mapped to the target coordinate system to control the state of the second object in the target region. The embodiments of the present disclosure can reduce perception deviation in the interaction process, so that the state of the second object meets the expectation of the user.

In some embodiments of the present disclosure, a calculation mode of a modulus of the second displacement vector is related to a positional relationship among the first displacement vector, the user local coordinate system, and the target coordinate system. In some embodiments, the positional relationship among the three includes a first positional relationship and a second positional relationship, and the second displacement vector adopts different calculation modes in the case of the first positional relationship and the second positional relationship. In some embodiments, with the first displacement vector unchanged, the user wants to express different controls as the user local coordinate system changes. In the present disclosure, it is considered that in this case, if the second displacement vector adopts a single calculation mode, it is prone to a large deviation between the control of the second object and the expectation of the user. Therefore, for cases of different positional relationships, different control modes are adopted, thereby improving the user experience.

In some embodiments of the present disclosure, the obtaining the second displacement vector according to the harmonic calculation result of the first projection vector and the second projection vector includes: using a direction of a vector obtained according to the harmonic calculation result of the first projection vector and the second projection vector as a direction of the second displacement vector; and determining a modulus of the second displacement vector according to a positional relationship among the first displacement vector, the user local coordinate system, and the target coordinate system. In some embodiments, the direction of the vector obtained according to the harmonic calculation result of the first projection vector and the second projection vector is the same as the direction of the second displacement vector, but the modulus of the second displacement vector is related to the positional relationship among the three, so as to avoid a large deviation between the expectation of the user and the actual control result of the second object.

In some embodiments of the present disclosure, the determining the modulus of the second displacement vector according to the positional relationship among the first displacement vector, the user local coordinate system, and the target coordinate system includes: determining that the modulus of the second displacement vector is equal to a modulus of the first displacement vector in response to a first offset angle being within a range of zero to a second offset angle, or the first offset angle being within a range of 180 degrees to 180 degrees plus the second offset angle. The first offset angle is an offset angle of the first displacement vector relative to the target coordinate system, and the second offset angle is an offset angle of the user local coordinate system relative to the target coordinate system.

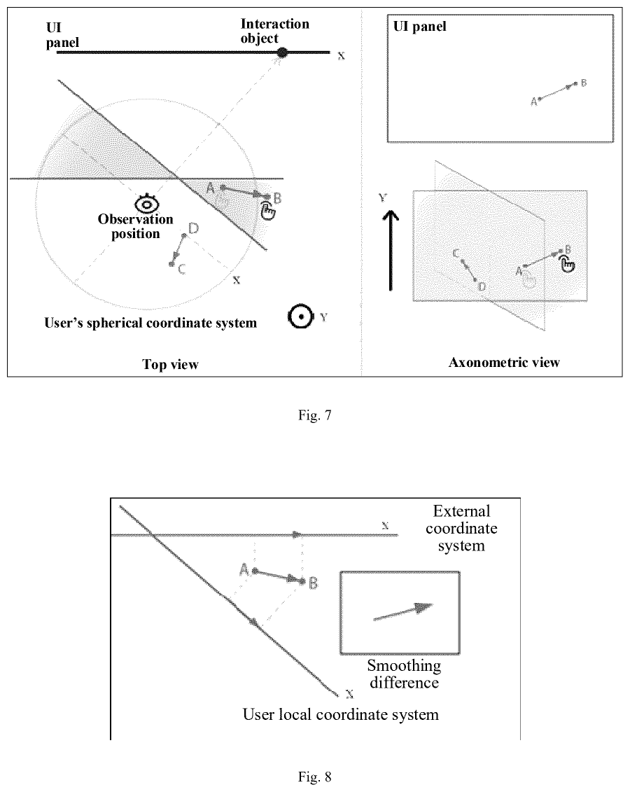

In some embodiments, the offset angle has a positive direction, and a direction opposite to the positive direction is a negative direction. The offset angle in the positive direction is a positive value, and the offset angle in the negative direction is a negative value. As shown in FIG. 7, the target coordinate system in FIG. 7 is a plane coordinate system, which is parallel to a display panel (UI panel) and corresponds to a mapping plane in the user local coordinate system (a spherical coordinate system of the user). The x-axis of the target coordinate system in FIG. 7 has an angle with the x-axis of the user local coordinate system, and the y-axis of the two coordinate systems is parallel. The mapping plane is a plane where the x-axis and the y-axis of the user local coordinate system are located. On the left side of FIG. 7, the mapping plane and the target coordinate system are translated to have an intersection line, forming two shaded areas in FIG. 7. The two shaded planes on the right side of FIG. 7 schematically represent the translated target coordinate system and the mapping plane, respectively. The shaded area on the left side in the top view of FIG. 7 represents an area with an offset angle ranging from 180 degrees to 180 degrees plus the second offset angle, the shaded area on the right side in the top view represents an area with an offset angle ranging from zero to the second offset angle, and the displacement vector from A to B in FIG. 7 is a displacement vector within the range of zero to the second offset angle. When the first displacement vector is the displacement vector from A to B located in the shaded area of the top view in FIG. 7, the modulus of the second displacement vector is equal to the modulus of the first displacement vector. At this time, the deviation between the first displacement vector and the target coordinate system is small, so the distance that the user moves the first object is usually the distance that the user wants to control the second object. At this time, the modulus of the first displacement vector is directly used as the modulus of the second displacement vector, which not only meets the expectation of the user, but also reduces the calculation amount.

In some embodiments of the present disclosure, in response to the first offset angle not being within the range of zero to the second offset angle, and the first offset angle not being within the range of 180 degrees to 180 degrees plus the second offset angle, a modulus of a vector obtained according to the harmonic calculation result of the first projection vector and the second projection vector is used as the modulus of the second displacement vector. In some embodiments, as shown in FIG. 7, when the first displacement vector is the displacement vector from D to C, the first displacement vector is located outside the shaded area of the top view in FIG. 7. At this time, the first displacement vector has a large first offset angle relative to the target coordinate system. Therefore, whether the modulus of the second displacement vector is the modulus of the first displacement vector, the modulus of the first projection vector, or the modulus of the second projection vector, it may be greatly different from the expectation of the user. Therefore, the modulus of the vector after the harmonic calculation is used as the modulus of the second displacement vector here, so as to avoid a large difference from the expectation of the user.

In some embodiments of the present disclosure, the target region is a display region of a display screen, the display screen is parallel to two coordinate axes in the target coordinate system, and the user local coordinate system has a mapping plane corresponding to the display screen. In some embodiments, as shown in FIG. 3, a plane where the x-axis and the y-axis of the user local coordinate system are located is the mapping plane. The mapping plane and the display screen have the y-axis in the same direction and the x-axis in different directions. The x-axis and the y-axis may also be referred to as a horizontal coordinate axis and a vertical coordinate axis. As shown in FIG. 7, the offset angle of the user local coordinate system relative to the target coordinate system is the offset angle of the mapping plane relative to the display screen. The offset angle of the first displacement vector relative to the target coordinate system is the offset angle of the first displacement vector relative to the display screen. In some embodiments, the offset angle of the user local coordinate system relative to the target coordinate system is not greater than 90 degrees.

In some embodiments of the present disclosure, the harmonic calculation is performed by using a balance difference algorithm. In some embodiments, as shown in FIG. 8, which shows a schematic diagram of performing the balance difference calculation when the first displacement vector is the displacement vector from A to B in FIG. 7, the projection vectors of the first displacement vector in the external coordinate system and the user local coordinate system are first calculated, and then the smoothing difference calculation is performed with the two projection vectors.

In the embodiments of the present disclosure, when the first displacement vector is within the offset angle range shown in the shaded area of the top view in FIG. 7 (for example, from A to B), the modulus of the second moving vector is equal to the modulus of the first moving vector, and the direction of the second moving vector is the direction of the smoothing difference between the first projection vector and the second projection vector. The first moving vector is outside the two offset angle ranges (for example, from C to D), and the modulus and direction of the second moving vector are the smoothing differences between the first projection vector and the second projection vector.

In some embodiments of the present disclosure, the controlling the state of the second object in the target region according to the second displacement vector includes: obtaining a target position coordinate by adding an initial position coordinate of the second object to the second displacement vector, and moving the second object according to the target position coordinate. The initial position coordinate is a position coordinate of the second object in the target coordinate system before the moving event of the first object. In some embodiments, the second displacement vector represents a moving direction and a moving distance of the second object, and the target position coordinate of the second object may be obtained by adding the initial position coordinate of the second object in the target coordinate system to the second displacement vector, and the second object may be moved to the target position coordinate. In some embodiments, when the target coordinate system and the user local coordinate system are three-dimensional coordinate systems, the three-dimensional initial position coordinates of the second object are respectively added with the second displacement vector to obtain the target position coordinates. When the target coordinate system is a two-dimensional plane coordinate system (such as an xy coordinate system) and the user local coordinate system is a three-dimensional coordinate system, the two-dimensional initial position coordinates of the second object are respectively added with two values (such as the x value and the y value) in the second displacement vector corresponding to the two-dimensional plane coordinate system to obtain the target position coordinates.

In some embodiments of the present disclosure, the execution end of the method is an extended reality device. In some embodiments, the target region is a virtual or real display screen, for example, a virtual display plane in a virtual reality space, and the second object is a virtual object displayed in the display screen. In some embodiments, the first object is a controller that controls the second object or a hand of the user, and the first object may be a handle of a virtual reality device.

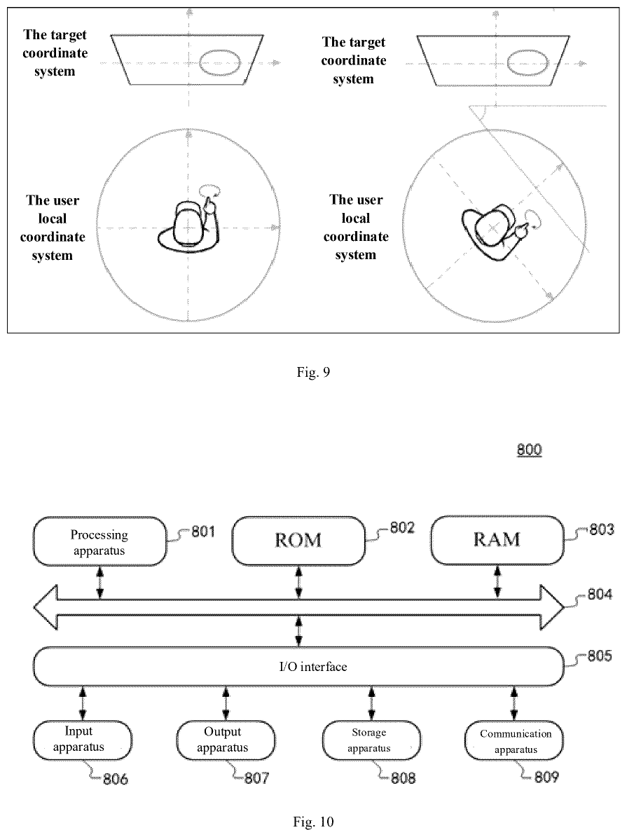

In some embodiments of the present disclosure, when the user local coordinate system is inconsistent with the target coordinate system, two perception calculation methods are reconciled to improve the user experience. As shown in FIG. 9, the left and right sides of FIG. 9 show schematic diagrams of drawing a circle when the user is facing the display plane head-on and obliquely facing the display screen, respectively. By adopting the method proposed in the embodiments of the present disclosure, after the harmonic calculation, even if the user is not facing the display screen head-on to draw the graphics, the real-time drawing path of the user will be met, and the graphics that meet the actual expectation of the user will be generated on the display screen. The present disclosure improves the efficiency and accuracy of interaction, reduces the learning cost of the user, and provides a better user experience.

The present disclosure further provides an interaction control apparatus, the apparatus includes:
a processing unit, configured to determine a first displacement vector of a first object in response to a moving event of the first object;
the processing unit is further configured to: determine a first projection vector of the first displacement vector in a user local coordinate system and a second projection vector of the first displacement vector in a target coordinate system;
the processing unit is further configured to: obtain a second displacement vector according to a harmonic calculation result of the first projection vector and the second projection vector;
a control unit, configured to control a state of a second object in a target region according to the second displacement vector;
the target coordinate system is a coordinate system used for the target region, and the second object is limited in the target region.

In some embodiments, the obtaining the second displacement vector according to the harmonic calculation result of the first projection vector and the second projection vector includes:
using a direction of a vector obtained according to the harmonic calculation result of the first projection vector and the second projection vector as a direction of the second displacement vector; and
determining a modulus of the second displacement vector according to a positional relationship among the first displacement vector, the user local coordinate system, and the target coordinate system.

In some embodiments, the determining the modulus of the second displacement vector according to the positional relationship among the first displacement vector, the user local coordinate system, and the target coordinate system includes:
determining that the modulus of the second displacement vector is equal to a modulus of the first displacement vector in response to a first offset angle being within a range of zero to a second offset angle, or the first offset angle being within a range of 180 degrees to 180 degrees plus the second offset angle; or,
using a modulus of a vector obtained according to the harmonic calculation result of the first projection vector and the second projection vector as the modulus of the second displacement vector in response to the first offset angle not being within the range of zero to the second offset angle, and the first offset angle not being within the range of 180 degrees to 180 degrees plus the second offset angle;
the first offset angle is an offset angle of the first displacement vector relative to the target coordinate system, and the second offset angle is an offset angle of the user local coordinate system relative to the target coordinate system.

In some embodiments, the offset angle of the user local coordinate system relative to the target coordinate system is not greater than 90 degrees.

In some embodiments, the target region is a display region of a display screen, the display screen is parallel to two coordinate axes in the target coordinate system, and the user local coordinate system has a mapping plane corresponding to the display screen;
the offset angle of the user local coordinate system relative to the target coordinate system is an offset angle of the mapping plane relative to the display screen; and
the offset angle of the first displacement vector relative to the target coordinate system is an offset angle of the first displacement vector relative to the display screen.

In some embodiments, the controlling the state of the second object in the target region according to the second displacement vector includes:
obtaining a target position coordinate by adding an initial position coordinate of the second object to the second displacement vector, and moving the second object according to the target position coordinate;
the initial position coordinate is a position coordinate of the second object in the target coordinate system before the moving event of the first object.

In some embodiments, the offset angle of the user local coordinate system relative to the target coordinate system is greater than zero. In some embodiments, the harmonic calculation is performed by using a balance difference algorithm. In some embodiments, the target region is a virtual or real display screen, and the second object is a virtual object displayed in the display screen. In some embodiments, the interaction control apparatus is an extended reality device. In some embodiments, the first object is a controller that controls the second object or a hand of the user.

For the apparatus embodiments, since they basically correspond to the method embodiments, reference may be made to the descriptions of the method embodiments for relevant parts. The apparatus embodiments described above are only illustrative, and the modules described as separate modules may or may not be separate. Some or all of the modules may be selected according to actual needs to achieve the purpose of the solutions of the embodiments. Those of ordinary skill in the art can understand and implement without paying creative labor.

The above describes the method and apparatus of the present disclosure based on the embodiments and application examples. In addition, the present disclosure further provides an electronic device and a computer-readable storage medium, which are described below.

Reference is made to FIG. 10 below, which illustrates a schematic structural diagram of an electronic device (such as a terminal device or a server) 800 suitable for implementing the embodiments of the present disclosure. The terminal device in the embodiments of the present disclosure may include, but is not limited to, a mobile terminal such as a mobile phone, a laptop, a digital broadcast receiver, a PDA (personal digital assistant), a tablet, a PMP (portable multimedia player), a vehicle-mounted terminal (such as a vehicle-mounted navigation terminal), and a fixed terminal such as a digital TV, a desktop computer, and the like. The electronic device shown in the figure is only an example, and should not impose any limitation on the functions and use scope of the embodiments of the present disclosure.

The electronic device 800 may include a processing apparatus (such as a central processing unit, a graphics processor, etc.) 801, which may perform various appropriate actions and processing according to a program stored in a read-only memory (ROM) 802 or a program loaded from a storage apparatus 808 into a random access memory (RAM) 803. The RAM 803 also stores various programs and data required for the operation of the electronic device 800. The processing apparatus 801, the ROM 802, and the RAM 803 are connected to each other through a bus 804. An input/output (I/O) interface 805 is also connected to the bus 804.

Generally, the following apparatus may be connected to the I/O interface 805: an input apparatus 806 including, for example, a touchscreen, a touchpad, a keyboard, a mouse, a camera, a microphone, an accelerometer, a gyroscope, etc.; an output apparatus 807 including, for example, a liquid crystal display (LCD), a speaker, a vibrator, etc.; a storage apparatus 808 including, for example, a magnetic tape, a hard disk, etc.; and a communication apparatus 809. The communication apparatus 809 may allow the electronic device 800 to perform wireless or wired communication with other devices to exchange data. Although the electronic device 800 with various apparatuses is shown in the figure, it should be understood that it is not required to implement or have all the illustrated apparatuses. Alternatively, more or fewer apparatuses may be implemented or provided.

In particular, according to the embodiments of the present disclosure, the process described above with reference to the flowchart may be implemented as a computer software program. For example, an embodiment of the present disclosure includes a computer program product, which includes a computer program carried on a computer-readable medium, and the computer program includes program codes for executing the method shown in the flowchart. In such an embodiment, the computer program may be downloaded and installed from the network through the communication apparatus 809, or installed from the storage apparatus 808, or installed from the ROM 802. When the computer program is executed by the processing apparatus 801, the above functions defined in the method of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in conjunction with an instruction execution system, apparatus, or device. In the present disclosure, the computer-readable signal medium may include a data signal propagated in a baseband or as a part of a carrier wave, which carries computer-readable program codes. This propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program for use by or in conjunction with an instruction execution system, apparatus, or device. The program codes contained on the computer-readable medium may be transmitted by any suitable medium, including but not limited to: a wire, an optical cable, RF (radio frequency), etc., or any suitable combination thereof.

In some implementations, the client and the server may communicate using any currently known or future developed network protocol such as the Hypertext transfer protocol (HTTP) and may be interconnected with any form or medium of digital data communication (e.g., a communication network). Examples of the communication network include a local area network (“LAN”), a wide area network (“WAN”), an internetwork (e.g., the Internet), and an end-to-end network (e.g., an ad hoc end-to-end network), as well as any currently known or future developed network.

The above computer-readable medium may be contained in the above electronic device, or may also exist alone without being assembled into the electronic device.

The above computer-readable medium carries one or more programs, and when the above one or more programs are executed by the electronic device, the electronic device is caused to execute the above method of the present disclosure.

Computer program codes for performing the operations of the present disclosure may be written in one or more programming languages or a combination thereof. The above programming languages include object-oriented programming languages such as Java, Smalltalk, C++, and also include conventional procedural programming languages such as the “C” language or similar programming languages. The program codes may be executed entirely on a user computer, partly on a user computer, as a stand-alone software package, partly on a user computer and partly on a remote computer, or entirely on a remote computer or server. In the case of a remote computer, the remote computer may be connected to the user computer through any type of network, including a local area network (LAN) or a wide area network (WAN), or may be connected to an external computer (for example, through the Internet using an Internet service provider).

The flowcharts and block diagrams in the drawings illustrate the architecture, functionality, and operation of possible implementations of the systems, methods, and computer program products according to various embodiments of the present disclosure. In this regard, each block in the flowcharts or block diagrams may represent a module, a program segment, or a portion of codes, which includes one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may be implemented by a combination of dedicated hardware and computer instructions.

The units involved in the embodiments of the present disclosure may be implemented in software or hardware. The name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, an electrical, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

According to one or more embodiments of the present disclosure, an interaction control method is provided, including:
determining a first displacement vector of a first object in response to a moving event of the first object;
determining a first projection vector of the first displacement vector in a user local coordinate system and a second projection vector of the first displacement vector in a target coordinate system;
obtaining a second displacement vector according to a harmonic calculation result of the first projection vector and the second projection vector; and
controlling a state of a second object in a target region according to the second displacement vector;
the target coordinate system is a coordinate system used for the target region, and the second object is limited in the target region.

According to one or more embodiments of the present disclosure, an interaction control method is provided, where the obtaining the second displacement vector according to the harmonic calculation result of the first projection vector and the second projection vector includes:
using a direction of a vector obtained according to the harmonic calculation result of the first projection vector and the second projection vector as a direction of the second displacement vector; and
determining a modulus of the second displacement vector according to a positional relationship among the first displacement vector, the user local coordinate system, and the target coordinate system.

According to one or more embodiments of the present disclosure, an interaction control method is provided, the determining the modulus of the second displacement vector according to the positional relationship between the first displacement vector, the user local coordinate system, and the target coordinate system includes:
determining that the modulus of the second displacement vector is equal to a modulus of the first displacement vector in response to a first offset angle being within a range of zero to a second offset angle, or the first offset angle being within a range of 180 degrees to 180 degrees plus the second offset angle; or,
using a modulus of a vector obtained according to the harmonic calculation result of the first projection vector and the second projection vector as the modulus of the second displacement vector in response to the first offset angle not being within the range of zero to the second offset angle, and the first offset angle not being within the range of 180 degrees to 180 degrees plus the second offset angle;
the first offset angle is an offset angle of the first displacement vector relative to the target coordinate system, and the second offset angle is an offset angle of the user local coordinate system relative to the target coordinate system.

According to one or more embodiments of the present disclosure, an interaction control method is provided, the offset angle of the user local coordinate system relative to the target coordinate system is not greater than 90 degrees.

According to one or more embodiments of the present disclosure, an interaction control method is provided, the target region is a display region of a display screen, the display screen is parallel to two coordinate axes in the target coordinate system, and the user local coordinate system has a mapping plane corresponding to the display screen;
the offset angle of the user local coordinate system relative to the target coordinate system is an offset angle of the mapping plane relative to the display screen; and
the offset angle of the first displacement vector relative to the target coordinate system is an offset angle of the first displacement vector relative to the display screen.

According to one or more embodiments of the present disclosure, an interaction control method is provided, the controlling the state of the second object in the target region according to the second displacement vector includes:
obtaining a target position coordinate by adding an initial position coordinate of the second object to the second displacement vector, and moving the second object according to the target position coordinate;
the initial position coordinate is a position coordinate of the second object in the target coordinate system before the moving event of the first object.

According to one or more embodiments of the present disclosure, an interaction control method is provided, satisfying at least one of the following:
the offset angle of the user local coordinate system relative to the target coordinate system is greater than zero;
the harmonic calculation is performed by using a balance difference algorithm;
the target region is a virtual or real display screen, and the second object is a virtual object displayed in the display screen;
an execution end of the method is an extended reality device; and
the first object is a controller that controls the second object or a hand of a user.

According to one or more embodiments of the present disclosure, an interaction control apparatus is provided, including:
a processing unit, configured to determine a first displacement vector of a first object in response to a moving event of the first object;
the processing unit is further configured to: determine a first projection vector of the first displacement vector in a user local coordinate system and a second projection vector of the first displacement vector in a target coordinate system;
the processing unit is further configured to: obtain a second displacement vector according to a harmonic calculation result of the first projection vector and the second projection vector;
a control unit, configured to control a state of a second object in a target region according to the second displacement vector;
the target coordinate system is a coordinate system used for the target region, and the second object is limited in the target region.

According to one or more embodiments of the present disclosure, an electronic device is provided, including: at least one memory and at least one processor;
the at least one memory is configured to store program codes, and the at least one processor is configured to invoke the program codes stored in the at least one memory to perform the above method.

According to one or more embodiments of the present disclosure, a computer-readable storage medium is provided, the computer-readable storage medium is configured to store program codes, the program codes, when executed by a processor, cause the processor to perform the above method.

The above description is only preferred embodiments of the present disclosure and an illustration of the applied technical principles. Those skilled in the art should understand that the disclosure scope involved in the present disclosure is not limited to the technical solutions formed by the specific combination of the above technical features, and should also cover other technical solutions formed by any combination of the above technical features or equivalent features thereof without departing from the above disclosure concept. For example, the technical solutions formed by replacing the above features with the technical features with similar functions disclosed in the present disclosure (but not limited to).

In addition, although operations are depicted in a particular order, it should not be understood that these operations are required to be performed in the specific order shown or in a sequential order. Under certain circumstances, multitasking and parallel processing may be advantageous. Likewise, although the above discussion contains several specific implementation details, these should not be construed as limitations on the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or method logical actions, it should be understood that the subject matter defined in the appended claims is not necessarily limited to the specific features or actions described above. Rather, the specific features and actions described above are merely exemplary forms of implementing the claims.

1. An interaction control method, comprising:
determining a first displacement vector of a first object in response to a moving event of the first object;
determining a first projection vector of the first displacement vector in a user local coordinate system and a second projection vector of the first displacement vector in a target coordinate system;
obtaining a second displacement vector according to a harmonic calculation result of the first projection vector and the second projection vector; and
controlling a state of a second object in a target region according to the second displacement vector;
wherein the target coordinate system is a coordinate system used by the target region, and the second object is limited in the target region.

2. The method according to claim 1, wherein the obtaining a second displacement vector according to a harmonic calculation result of the first projection vector and the second projection vector comprises:
using a direction of a vector obtained according to the harmonic calculation result of the first projection vector and the second projection vector as a direction of the second displacement vector; and
determining a modulus of the second displacement vector according to a positional relationship among the first displacement vector, the user local coordinate system, and the target coordinate system.

3. The method according to claim 2, wherein the determining a modulus of the second displacement vector according to a positional relationship among the first displacement vector, the user local coordinate system, and the target coordinate system comprises:
determining that the modulus of the second displacement vector is equal to a modulus of the first displacement vector in response to a first offset angle being within a range of zero to a second offset angle, or the first offset angle being within a range of 180 degrees to 180 degrees plus the second offset angle; or, using a modulus of a vector obtained according to the harmonic calculation result of the first projection vector and the second projection vector as the modulus of the second displacement vector in response to the first offset angle not being within the range of zero to the second offset angle, and the first offset angle not being within the range of 180 degrees to 180 degrees plus the second offset angle;
wherein the first offset angle is an offset angle of the first displacement vector relative to the target coordinate system, and the second offset angle is an offset angle of the user local coordinate system relative to the target coordinate system.

4. The method according to claim 3, wherein the offset angle of the user local coordinate system relative to the target coordinate system is not greater than 90 degrees.

5. The method according to claim 3, wherein the target region is a display region of a display screen, the display screen is parallel to two coordinate axes in the target coordinate system, and the user local coordinate system has a mapping plane corresponding to the display screen;
the offset angle of the user local coordinate system relative to the target coordinate system is an offset angle of the mapping plane relative to the display screen; and
the offset angle of the first displacement vector relative to the target coordinate system is an offset angle of the first displacement vector relative to the display screen.

6. The method according to claim 1, wherein the controlling a state of a second object in a target region according to the second displacement vector comprises:
obtaining a target position coordinate by adding an initial position coordinate of the second object to the second displacement vector, and moving the second object according to the target position coordinate;
wherein the initial position coordinate is a position coordinate of the second object in the target coordinate system before the moving event of the first object.

7. The method according to claim 1, wherein at least one selected from a group consist of the following is satisfied:
an offset angle of the user local coordinate system relative to the target coordinate system is greater than zero;
harmonic calculation is performed by using a balance difference algorithm;
the target region is a virtual or real display screen, and the second object is a virtual object displayed in the display screen;
an execution end of the method is an extended reality device; and
the first object is a controller that controls the second object or a hand of a user.

8. An electronic device, comprising:
at least one memory and at least one processor;
wherein the at least one memory is configured to store program codes, and the at least one processor is configured to invoke the program codes stored in the at least one memory to perform the method according to an interaction control method, which comprises:
determining a first displacement vector of a first object in response to a moving event of the first object;
determining a first projection vector of the first displacement vector in a user local coordinate system and a second projection vector of the first displacement vector in a target coordinate system;
obtaining a second displacement vector according to a harmonic calculation result of the first projection vector and the second projection vector; and
controlling a state of a second object in a target region according to the second displacement vector;
wherein the target coordinate system is a coordinate system used by the target region, and the second object is limited in the target region.

9. The electronic device according to claim 8, wherein the obtaining a second displacement vector according to a harmonic calculation result of the first projection vector and the second projection vector t comprises:
using a direction of a vector obtained according to the harmonic calculation result of the first projection vector and the second projection vector as a direction of the second displacement vector; and
determining a modulus of the second displacement vector according to a positional relationship among the first displacement vector, the user local coordinate system, and the target coordinate system.

10. The electronic device according to claim 9, wherein the determining a modulus of the second displacement vector according to a positional relationship among the first displacement vector, the user local coordinate system, and the target coordinate system comprises:
determining that the modulus of the second displacement vector is equal to a modulus of the first displacement vector in response to a first offset angle being within a range of zero to a second offset angle, or the first offset angle being within a range of 180 degrees to 180 degrees plus the second offset angle; or,
using a modulus of a vector obtained according to the harmonic calculation result of the first projection vector and the second projection vector as the modulus of the second displacement vector in response to the first offset angle not being within the range of zero to the second offset angle, and the first offset angle not being within the range of 180 degrees to 180 degrees plus the second offset angle;
wherein the first offset angle is an offset angle of the first displacement vector relative to the target coordinate system, and the second offset angle is an offset angle of the user local coordinate system relative to the target coordinate system.

11. The electronic device according to claim 10, wherein the offset angle of the user local coordinate system relative to the target coordinate system is not greater than 90 degrees.

12. The electronic device according to claim 10, wherein the target region is a display region of a display screen, the display screen is parallel to two coordinate axes in the target coordinate system, and the user local coordinate system has a mapping plane corresponding to the display screen;
the offset angle of the user local coordinate system relative to the target coordinate system is an offset angle of the mapping plane relative to the display screen; and
the offset angle of the first displacement vector relative to the target coordinate system is an offset angle of the first displacement vector relative to the display screen.

13. The electronic device according to claim 8, wherein the controlling a state of a second object in a target region according to the second displacement vector comprises:
obtaining a target position coordinate by adding an initial position coordinate of the second object to the second displacement vector, and moving the second object according to the target position coordinate;
wherein the initial position coordinate is a position coordinate of the second object in the target coordinate system before the moving event of the first object.

14. The electronic device according to claim 8, wherein at least one selected from a group consist of the following is satisfied:
an offset angle of the user local coordinate system relative to the target coordinate system is greater than zero;
harmonic calculation is performed by using a balance difference algorithm;
the target region is a virtual or real display screen, and the second object is a virtual object displayed in the display screen;
an execution end of the method is an extended reality device; and
the first object is a controller that controls the second object or a hand of a user.

15. A non-transient computer-readable storage medium, wherein the computer-readable storage medium is configured to store program codes, the program codes, when executed by a processor, cause the processor to perform an interaction control method, which comprises:
determining a first displacement vector of a first object in response to a moving event of the first object;
determining a first projection vector of the first displacement vector in a user local coordinate system and a second projection vector of the first displacement vector in a target coordinate system;
obtaining a second displacement vector according to a harmonic calculation result of the first projection vector and the second projection vector; and
controlling a state of a second object in a target region according to the second displacement vector;
wherein the target coordinate system is a coordinate system used by the target region, and the second object is limited in the target region.

16. The non-transient computer-readable storage medium according to claim 15, wherein the obtaining a second displacement vector according to a harmonic calculation result of the first projection vector and the second projection vector comprises:
using a direction of a vector obtained according to the harmonic calculation result of the first projection vector and the second projection vector as a direction of the second displacement vector; and
determining a modulus of the second displacement vector according to a positional relationship among the first displacement vector, the user local coordinate system, and the target coordinate system.

17. The non-transient computer-readable storage medium according to claim 16, wherein the determining a modulus of the second displacement vector according to a positional relationship among the first displacement vector, the user local coordinate system, and the target coordinate system comprises:
determining that the modulus of the second displacement vector is equal to a modulus of the first displacement vector in response to a first offset angle being within a range of zero to a second offset angle, or the first offset angle being within a range of 180 degrees to 180 degrees plus the second offset angle; or, using a modulus of a vector obtained according to the harmonic calculation result of the first projection vector and the second projection vector as the modulus of the second displacement vector in response to the first offset angle not being within the range of zero to the second offset angle, and the first offset angle not being within the range of 180 degrees to 180 degrees plus the second offset angle;
wherein the first offset angle is an offset angle of the first displacement vector relative to the target coordinate system, and the second offset angle is an offset angle of the user local coordinate system relative to the target coordinate system.

18. The non-transient computer-readable storage medium according to claim 17, wherein the offset angle of the user local coordinate system relative to the target coordinate system is not greater than 90 degrees.

19. The non-transient computer-readable storage medium according to claim 17, wherein the target region is a display region of a display screen, the display screen is parallel to two coordinate axes in the target coordinate system, and the user local coordinate system has a mapping plane corresponding to the display screen;
the offset angle of the user local coordinate system relative to the target coordinate system is an offset angle of the mapping plane relative to the display screen; and
the offset angle of the first displacement vector relative to the target coordinate system is an offset angle of the first displacement vector relative to the display screen.

20. The non-transient computer-readable storage medium according to claim 15, wherein the controlling a state of a second object in a target region according to the second displacement vector comprises:
obtaining a target position coordinate by adding an initial position coordinate of the second object to the second displacement vector, and moving the second object according to the target position coordinate;
wherein the initial position coordinate is a position coordinate of the second object in the target coordinate system before the moving event of the first object.
